(19) United States
(12) Patent Application Publication
(10) Pub. No.: US 2025/0234168 A1
(43) Pub. Date: Jul. 17, 2025

(54) DEVICE, METHOD AND NON-TRANSITORY COMPUTER-READABLE STORAGE MEDIUM FOR REGISTERING OTHER ELECTRONIC DEVICES

(71) Applicant: Samsung Electronics Co., Ltd., Suwon-si (KR)

(72) Inventors: Kwanghoon HAN, Suwon-si (KR); Chunho PARK, Suwon-si (KR); Junsu CHOI, Suwon-si (KR)

(21) Appl. No.: 19/170,574

(22) Filed: Apr. 4, 2025

Related U.S. Application Data
(63) Continuation of application No. PCT/KR2023/013044, filed on Sep. 1, 2023.

(30) Foreign Application Priority Data
Oct. 7, 2022 (KR) 10-2022-0128722
Oct. 31, 2022 (KR) 10-2022-0143189

(51) Int. Cl. H04W 4/23; H04B 17/318; H04W 60/04

(52) U.S. Cl. CPC H04W 4/23; H04B 17/318; H04W 60/04

(57) ABSTRACT

An electronic device is provided. The electronic device includes wireless communication circuitry at least one processor comprising processing circuitry, and memory comprising one or more storage media storing instructions, wherein the instructions, when executed by the at least one processor individually or collectively, cause the electronic device to receive a first advertising signal broadcasted from another electronic device, using the wireless communication circuitry, based on a reception strength of the first advertising signal greater than a reference reception strength, transmit, to the other electronic device, a connection request, using the wireless communication circuitry, based at least in part on a connection with the other electronic device established based at least in part on the connection request, receive a second advertising signal broadcasted with a second transmit (Tx) power lower than a first Tx power of the first advertising signal from the other electronic device, using the wireless communication circuitry, and based at least in part on the reception of the second advertising signal, register the other electronic device to an external electronic device.

### CROSS-REFERENCE TO RELATED APPLICATION(S)

This application is a continuation application, claiming priority under 35 U.S.C. § 365(c), of an International application No. PCT/KR2023/013044, filed on Sep. 1, 2023, which is based on and claims the benefit of a Korean patent application number 10-2022-0128722, filed on Oct. 7, 2022, in the Korean Intellectual Property Office, and of a Korean patent application number 10-2022-0143189, filed on Oct. 31, 2022, in the Korean Intellectual Property Office, the disclosure of each of which is incorporated by reference herein in its entirety.

### BACKGROUND

### 1. Field

The disclosure relates to a wireless environment. More particularly, the disclosure relates to an electronic device, a method, and a non-transitory computer-readable storage medium for registering other electronic devices.

### 2. Description of Related Art

Compared to legacy Bluetooth® (or classic Bluetooth), Bluetooth® low energy (BLE) may provide reduced power consumption and provide at least a similar or often greater communication range between connected devices. BLE may be provided on an industrial, scientific, and medical (ISM) radio band.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and a non-transitory computer-readable storage medium for registering other electronic devices.

Additional aspects will be set forth in part in the description which follows and, in part, will be apparent from the description, or may be learned by practice of the presented embodiments.

In accordance with an aspect of the disclosure, an electronic device is provided. The electronic device includes wireless communication circuitry, at least one processor comprising processing circuitry, and memory comprising one or more storage media storing instructions, wherein the instructions, when executed by the at least one processor individually or collectively, cause the electronic device to receive a first advertising signal broadcasted from another electronic device, using the wireless communication circuitry, based on a reception strength of the first advertising signal greater than a reference reception strength, transmit, to the other electronic device, a connection request, using the wireless communication circuitry based at least in part on a connection with the other electronic device established based at least in part on the connection request, receive a second advertising signal broadcasted with a second transmit (Tx) power lower than a first Tx power of the first advertising signal from the other electronic device, using the wireless communication circuitry, and based at least in part on the reception of the second advertising signal, register the other electronic device to an external electronic device.

In accordance with another aspect of the disclosure, a method is provided. The method is executed in an electronic device comprising wireless communication circuitry. The method includes receiving a first advertising signal broadcasted from another electronic device, using the wireless communication circuitry. The method includes, based on a reception strength of the first advertising signal greater than a reference reception strength, transmitting, to the another electronic device, a connection request, using the wireless communication circuitry. The method includes, based at least in part on a connection with the another electronic device established based at least in part on the connection request, receiving the second advertising signal broadcasted with a second transmit (Tx) power lower than a first Tx power of the first advertising signal from the another electronic device, using the wireless communication circuitry. The method includes, based at least in part on the reception of the second advertising signal, registering the another electronic device to an external electronic device.

In accordance with another aspect of the disclosure, a non-transitory computer readable storage medium is provided. The non-transitory computer readable storage medium stores one or more programs. The one or more programs includes instructions that, when executed by a processor of an electronic device including wireless communication circuitry, cause the electronic device to receive a first advertising signal broadcasted from another electronic device, using the wireless communication circuitry. The one or more programs includes instructions that, when executed by the processor, cause the electronic device to, based on a reception strength of the first advertising signal greater than a reference reception strength, transmit, to the another electronic device, a connection request, using the wireless communication circuitry. The one or more programs includes instructions that, when executed by the processor, cause the electronic device to, based at least in part on a connection with the another electronic device established based at least in part on the connection request, receive the second advertising signal broadcasted with a second transmit (Tx) power lower than a first Tx power of the first advertising signal from the another electronic device, using the wireless communication circuitry. The one or more programs includes instructions that, when executed by the processor, cause the electronic device to, based at least in part on the reception of the second advertising signal, register the another electronic device to an external electronic device.

In accordance with another aspect of the disclosure, an electronic device is provided. The electronic device includes a display, wireless communication circuitry, at least one processor comprising processing circuitry, and memory comprising one or more storage media storing instructions wherein the instructions, when executed by the at least one processor individually or collectively, cause the electronic device to receive a first advertising signal broadcasted from another electronic device with a first transmit (Tx) power from among the first advertising signal and a second advertising signal broadcasted from the other electronic device with a second Tx power lower than the first Tx power, using the wireless communication circuitry, based on a reception strength of the first advertising signal greater than a reference reception strength, transmit, to the other electronic device, a connection request, using the wireless communication circuitry, in response to a connection with the other electronic device established based at least in part on the connection request, display information for informing to access the other electronic device, and identify whether the second advertising signal is received within a defined time, and based at least in part on the second advertising signal received within the defined time, register the other electronic device to an external electronic device.

In accordance with another aspect of the disclosure, a method is provided. The method is executed in an electronic device including a display and wireless communication circuitry. The method includes receiving, using the wireless communication circuitry, a first advertising signal broadcasted from another electronic device with a first transmit power from among the first advertising signal and a second advertising signal broadcasted from the another electronic device with a second TX power lower than the first Tx power. The method includes, based on a reception strength of the first advertising signal greater than a reference reception strength, transmitting, to the another electronic device, a connection request, using the wireless communication circuitry. The method includes, in response to a connection with the another electronic device established at least in part based on the connection request, displaying information for informing to access the another electronic device, and identifying whether the second advertising signal is received within a defined time. The method includes, based at least in part on the second advertising signal received within the defined time, registering the another electronic device to an external electronic device.

In accordance with another aspect of the disclosure, a non-transitory computer-readable storage medium is provided. The non-transitory computer-readable storage medium stores one or more programs. The one or more programs includes instructions that, when executed by a processor of an electronic device including a display and wireless communication circuitry, cause the electronic device to receive, using the wireless communication circuitry, a first advertising signal broadcasted from another electronic device with a first transmit power from among the first advertising signal and a second advertising signal broadcasted from the another electronic device with a second TX power lower than the first Tx power. The one or more programs includes instructions that, when executed by the processor, cause the electronic device to, based on a reception strength of the first advertising signal greater than a reference reception strength, transmit, to the another electronic device, a connection request, using the wireless communication circuitry. The one or more programs includes instructions that, when executed by the processor, cause the electronic device to, in response to a connection with the another electronic device established at least in part based on the connection request, display information for informing to access the another electronic device, and identify whether the second advertising signal is received within a defined time. The one or more programs includes instructions that, when executed by the processor, cause the electronic device to, based at least in part on the second advertising signal received within the defined time, register the another electronic device to an external electronic device.

In accordance with another aspect of the disclosure, an electronic device is provided. The electronic device includes a display, wireless communication circuitry, at least one processor comprising processing circuitry, and memory comprising one or more storage media storing instructions, wherein the instructions, when executed by the at least one processor individually or collectively, cause the electronic device to receive a first advertising signal broadcasted from another electronic device with a first transmit (Tx) power from among the first advertising signal and a second advertising signal broadcasted from the other electronic device with a second Tx power lower than the first Tx power, using the wireless communication circuitry, based on a reception strength of the first advertising signal greater than a reference reception strength, display information for informing to access the other electronic device, using the display, and identify whether the second advertising signal is received within a defined time establish a connection with the other electronic device, based on the second advertising signal received within the defined time, and register the other electronic device to an external electronic device, based at least in part on establishing of the connection.

In accordance with another aspect of the disclosure, a method is provided. The method is executed in an electronic device including wireless communication circuitry and a display. The method includes receiving, using the wireless communication circuitry, a first advertising signal broadcasted from another electronic device with a first transmit power from among the first advertising signal and a second advertising signal broadcasted from the another electronic device with a second TX power lower than the first Tx power. The method includes, based on a reception strength of the first advertising signal greater than a reference reception strength, displaying information for informing to access to the another electronic device, using the display, and identifying whether the second advertising signal is received within a defined time. The method includes, based on the second advertising signal received within the defined time, establishing a connection with the another electronic device. The method includes, based at least in part on establishing of the connection, registering the another electronic device to an external electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, by the electronic device, a first advertising signal broadcasted from another electronic device with a first transmit (Tx) power from among the first advertising signal and a second advertising signal broadcasted from the other electronic device with a second Tx power lower than the first Tx power, using wireless communication circuitry, based on a reception strength of the first advertising signal greater than a reference reception strength, displaying, by the electronic device, information for informing to access to the other electronic device, using a display, and identifying, by the electronic device, whether the second advertising signal is received within a defined time, establishing, by the electronic device, a connection with the other electronic device, based on the second advertising signal received within the defined time, and registering, by the electronic device, the other electronic device to an external electronic device, based at least in part on establishing of the connection.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of an environment including an electronic device and another electronic device according to an embodiment of the disclosure;

FIG. 2A illustrates a method of registering another electronic device using a first advertising signal and a second advertising signal according to an embodiment of the disclosure;

FIG. 2B illustrates an example of a state of an electronic device receiving a second advertising signal according to an embodiment of the disclosure;

FIG. 2C illustrates an example of information for informing that another electronic device is registered according to an embodiment of the disclosure;

FIG. 3 illustrates a method of registering another electronic device based on an identity resolving key (IRK) according to an embodiment of the disclosure;

FIG. 4A illustrates a method for displaying information for informing to access to another electronic device according to an embodiment of the disclosure;

FIG. 4B illustrates a method for displaying information for informing to access to another electronic device according to an embodiment of the disclosure;

FIG. 5A illustrates a method for displaying information for informing to change a state of another electronic device according to an embodiment of the disclosure;

FIG. 5B illustrates a method for informing to change a state of another electronic device according to an embodiment of the disclosure;

FIG. 6 illustrates a method for registering another electronic device based on security information according to an embodiment of the disclosure;

FIG. 7 illustrates a method for registering another electronic device, using a connection established based on a first advertising signal according to an embodiment of the disclosure;

FIG. 8 illustrates a method for registering another electronic device, using a connection established based on a second advertising signal according to an embodiment of the disclosure;

FIG. 9 illustrates a method for displaying information for informing to change a state of another electronic device, based on a connection request transmitted based on a first advertising signal according to an embodiment of the disclosure; and

FIG. 10 is a block diagram of an electronic device within a network environment according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

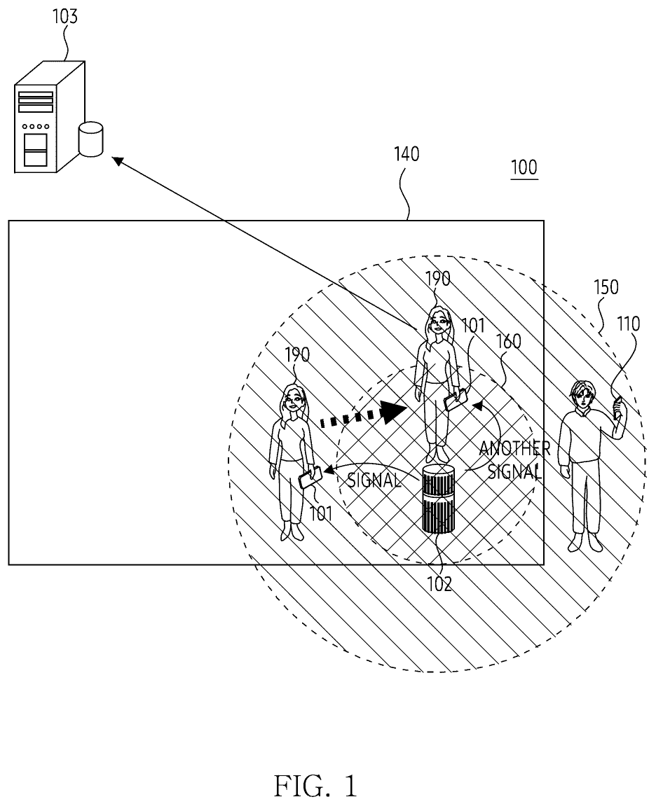

FIG. 1 illustrates an example of an environment including an electronic device and another electronic device according to an embodiment of the disclosure.

Referring to FIG. 1, an environment 100 may include an electronic device 101, another electronic device 102, and an external electronic device 103.

For example, the electronic device 101 may be a device that assists in registering the other electronic device 102 to the external electronic device 103 or registers the other electronic device 102 to the electronic device 101. For example, the electronic device 101 may register the other electronic device 102 to the electronic device 101. For example, the electronic device 101 may register the other electronic device 102 to the external electronic device 103. For example, the electronic device 101 may be a device having mobility. For example, the electronic device 101 may be a device having portability. For example, the electronic device 101 carried by a user 190 may be moved according to movement of the user 190. For example, the electronic device 101 may be a smartphone, a wearable device, a tablet, or a laptop computer. However, it is not limited thereto.

For example, the other electronic device 102 may be a device located within a space 140 for the user 190 of the electronic device 101.

For example, the other electronic device 102 may be a device to be registered to the external electronic device 103. For example, the other electronic device 102 may be registered to the external electronic device 103 to provide a service or to activate at least a portion of functions provided through the other electronic device 102. For example, the other electronic device 102 may be registered to the external electronic device 103 for a linkage with another device (e.g., the electronic device 101). For example, the registration may be performed based on authenticating or verifying the other electronic device 102. For example, security information of the other electronic device 102 may be used for the authentication or the verification. For example, unlike the other electronic device 102, the electronic device 101 may be a device, which is registered to the external electronic device 103 or authenticated or verified by the external electronic device 103. However, it is not limited thereto.

For example, convenience of a user input received to control the other electronic device 102 may be lower than convenience of a user input received to control the electronic device 101. For example, the other electronic device 102 may be controlled through a limited number of physical buttons, unlike the electronic device 101 which is controlled through a touch input on a display. For example, due to this difference in convenience, the other electronic device 102 may be registered to the external electronic device 103 through the electronic device 101. However, it is not limited thereto.

For example, the other electronic device 102 may have a more limited communication capability than the electronic device 101. For example, unlike the electronic device 101 which supports at least one of a cellular communication technique, a Wi-Fi communication technique, a Bluetooth communication technique, or a near field communication (NFC) technique, the other electronic device 102 may support at least one of Bluetooth communication technique or Wi-Fi communication technique. For example, due to a difference in communication capabilities, the other electronic device 102 may be registered to the external electronic device 103 through the electronic device 101. However, it is not limited thereto.

For example, the other electronic device 102 may be a device having lower mobility than the mobility of the electronic device 101. For example, the other electronic device 102 may be a device that does not have portability, unlike the electronic device 101. For example, the other electronic device 102 may be a robot cleaner, an artificial intelligence (AI) speaker, a smart lamp, a desktop computer, a television (TV), a refrigerator, an air purifier, an electronic oven, a microwave, or an induction. However, it is not limited thereto.

For example, the external electronic device 103, which is a device managing the other electronic device 102, may be a server. For example, the external electronic device 103 may be an IoT hub device for managing the other electronic device 102. For example, the external electronic device 103 may register the other electronic device 102. For example, the external electronic device 103 may register the other electronic device 102 to provide a service for updating one or more programs within the other electronic device 102. For example, the external electronic device 103 may register the other electronic device 102 to provide a service activating a portion of functions provided through the other electronic device 102. For example, the external electronic device 103 may register the other electronic device 102 to provide a service that stores information regarding the other electronic device 102. However, it is not limited thereto.

For example, authentication or verification between the electronic device 101 and the other electronic device 102 may be executed for registering the other electronic device 102 through the electronic device 101. For example, at least a portion of the authentication or at least a portion of the verification may be executed by identifying at least one of that the electronic device 101 is adjacent to the other electronic device 102 or the other electronic device 102 is adjacent to the electronic device 101. For example, the at least a portion of the authentication or the at least a portion of the verification may be executed through receiving a signal wirelessly transmitted from the other electronic device 102 at the electronic device 101 and/or receiving a signal wirelessly transmitted from the electronic device 101 at the other electronic device 102. For example, the at least a portion of the authentication or the at least a portion of the verification may be executed through receiving a distance between the electronic device 101 and the other electronic device 102 based on ranging via wireless communication. For example, wireless communication may be used for the at least a portion of the authentication or the at least a portion of the verification.

For example, the other electronic device 102 may broadcast a signal for the at least a portion of the authentication or the at least a portion of the verification. For example, the electronic device 101 may receive the signal. For example, since the reception of the signal by the electronic device 101 indicates that a distance between the electronic device 101 and the other electronic device 102 is less than a certain distance, the signal may be used for the at least a portion of the authentication or the at least a portion of the verification.

For example, a coverage of the signal, which indicates an area where the signal may reach with a reception strength greater than a reference reception strength, may be defined as an area 150. For example, when only the signal is used for the at least a portion of the authentication or the at least a portion of the verification, a registration of the other electronic device 102 through a device 110 located outside a space 140 for the user 190 may be performed. Such registration may be a registration through an authentication or a verification that is not intended by the user 190.

For example, such unintended registrations may be reduced by inputting at least one of additional authentication information or additional verification information into the electronic device 101. However, the input of at least one of the additional authentication information or the additional verification information may cause inconvenience.

For example, the electronic device 101 and the other electronic device 102 may perform transmission and reception of another signal distinct from the signal to reduce unintended registration while increasing convenience. For example, the other electronic device 102 may broadcast the other signal having a coverage narrower than the coverage of the other signal, for at least a portion of the authentication or at least a portion of the verification. For example, the coverage of the other signal may indicate an area where the other signal may reach. For example, the coverage of the other signal may be defined as an area 160 narrower than the area 150. For example, since the coverage of the other signal is within the space 140 for the user 190, the reception of the other signal by the device 110 may be reduced. For example, the electronic device 101 may execute at least a portion of the authentication or at least a portion of the verification, based on receiving the other signal.

The descriptions below exemplify a registration of the other electronic device 102 executed based on the signal and the other signal. In the descriptions below, the signal may be referred to as a first advertising signal, and the other signal may be referred to as a second advertising signal.

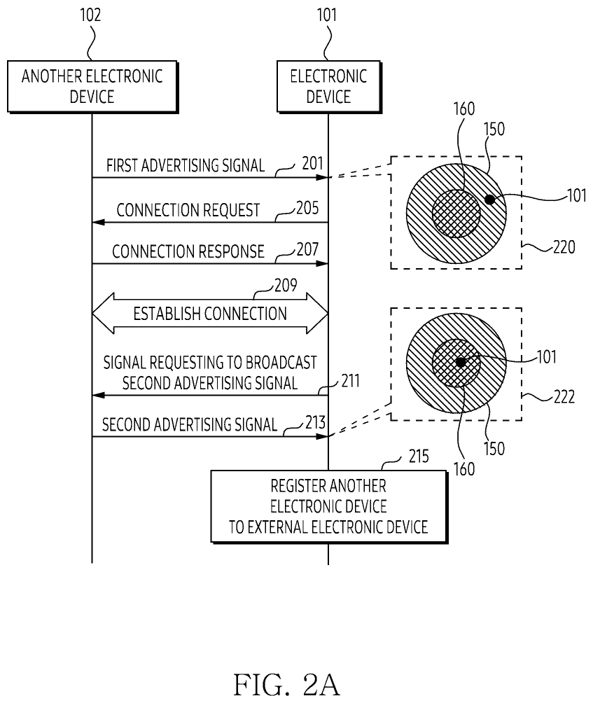

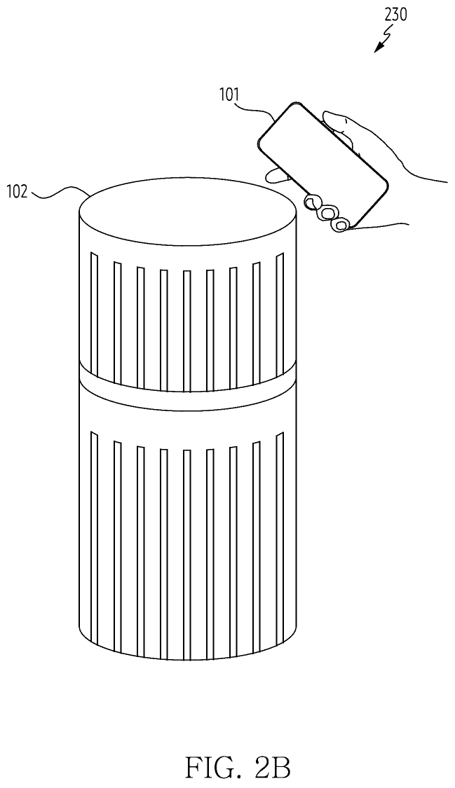

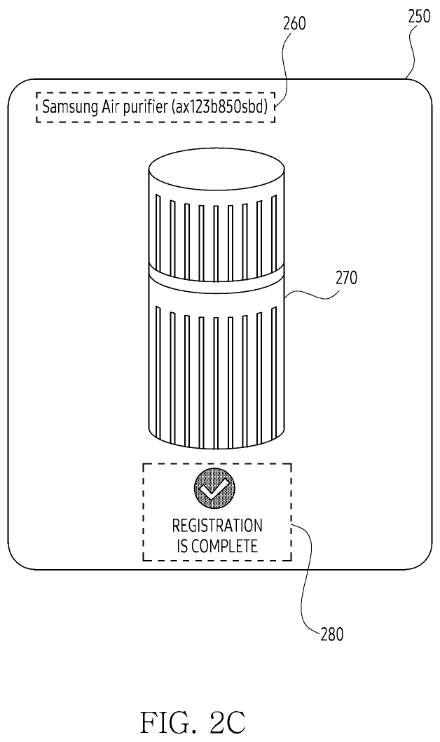

FIG. 2A illustrates a method of registering another electronic device using a first advertising signal and a second advertising signal according to an embodiment of the disclosure.

Referring to FIG. 2A, in operation 201, another electronic device 102 may broadcast a first advertising signal. For example, the first advertising signal may be broadcasted for discovery of the other electronic device 102. For example, a receiving device (e.g., the electronic device 101) of the first advertising signal may identify the other electronic device 102. For example, the first advertising signal may be broadcasted with a first transmit (Tx) power. For example, the coverage of the first advertising signal broadcasted with the first Tx power may correspond to an area 150. For example, the first Tx power may be about 1 decibel milliwatt (dBm). However, it is not limited thereto. For example, the first Tx power may vary according to at least one of an environment in which the other electronic device 102 is located, a function provided through the other electronic device 102, or a security level of the other electronic device 102.

For example, the first advertising signal may include information indicating the first Tx power. For example, a receiving device (e.g., the electronic device 101) of the first advertising signal may identify, based on the information, a distance between the receiving device and the other electronic device 102 or a state of a channel between the receiving device and the other electronic device 102. However, it is not limited thereto.

For example, the electronic device 101 may receive the first advertising signal broadcasted from the other electronic device 102. In an embodiment, when the electronic device 101 is located within the area 150 and outside an area 160 as shown in a state 220, a reception strength of the received first advertising signal may be greater than a reference reception strength. For example, the reference reception strength may be a preset or predetermined value. For example, the reference reception strength may be preset or predetermined based on at least one of an application being executed or a service being provided in the electronic device 101 or the other electronic device 102. For example, when the reception strength of the first advertising signal received from the other electronic device 102 is greater than the reference reception strength, it may indicate that a distance between the electronic device 101 and the other electronic device 102 is less than a certain distance. For example, the reception strength greater than the reference reception strength may indicate that a registration of the other electronic device 102 through the electronic device 101 is authorized. However, it is not limited thereto.

In operation 205, the electronic device 101 may transmit, to the other electronic device 102, a connection request, based on the reception strength of the first advertising signal greater than the reference reception strength. For example, the other electronic device 102 may receive the connection request from the electronic device 101.

In operation 207, the other electronic device 102 may, in response to the connection request, transmit a connection response to the electronic device 101. For example, the electronic device 101 may receive the connection response from the other electronic device 102.

In operation 209, the electronic device 101 and the other electronic device 102 may establish a connection between the electronic device 101 and the other electronic device 102, based on at least one of the connection request or the connection response.

In operation 211, the electronic device 101 may transmit, to the other electronic device 102, a signal requesting to broadcast a second advertising signal through the connection. For example, the other electronic device 102 may receive the signal from the electronic device 101.

In operation 213, the other electronic device 102 may, in response to the signal, broadcast the second advertising signal with a second Tx power lower than the first Tx power of the first advertising signal. For example, the second advertising signal may be broadcasted with the second Tx power to identify a device capable of accessing the other electronic device 102 among devices connected to the other electronic device 102 based on the first advertising signal. For example, since the device capable of accessing the other electronic device 102 may be a device having authority to register the other electronic device 102, the second advertising signal may be broadcasted with the second Tx power. For example, the second advertising signal broadcasted with the second Tx power may provide enhanced convenience because it does not require a user action to tag a designated area (e.g., an area where an antenna (or coil) for NFC communication is located) for receiving the second advertising signal, such as NFC communication. For example, the coverage of the second advertising signal broadcasted with the second Tx power may correspond to an area 160. For example, when the second Tx power is −30 dBm, the area 160 may be an area within about 1 meter (m) from the other electronic device 102. However, it is not limited thereto. For example, the second Tx power lower than the first Tx power may vary according to at least one of an environment in which the other electronic device 102 is located, a function provided through the other electronic device 102, or a security level of the other electronic device 102.

For example, after the first advertising signal is received, the electronic device 101 may move around or toward the other electronic device 102. For example, the electronic device 101 may be located within the area 160 according to the movement, as in a state 222. The electronic device 101 located within the area 160 may receive the second advertising signal. The electronic device 101 located within the area 160 (or the electronic device 101 receiving the second advertising signal) may be exemplified through FIG. 2B.

FIG. 2B illustrates an example of a state of an electronic device receiving a second advertising signal according to an embodiment of the disclosure.

Referring to FIG. 2B, a state of the electronic device 101 receiving the second advertising signal may correspond to a state 230. For example, in the state 230, the electronic device 101 may be adjacent to the other electronic device 102 or separated from the other electronic device 102. For example, in the state 230, the electronic device 101 may receive the second advertising signal without contacting with the other electronic device 102.

Referring to FIG. 2A, in operation 215, the electronic device 101 may register the other electronic device 102 to the external electronic device 103, based at least in part on the reception of the second advertising signal. For example, the electronic device 101 registering the other electronic device 102 to the external electronic device 103 may include the electronic device 101 registering the other electronic device 102 to the external electronic device 103 by transmitting information regarding the other electronic device 102 to the external electronic device 103. For example, the electronic device 101 registering the other electronic device 102 to the external electronic device 103 may include the electronic device 101 requesting the other electronic device 102 to register to the external electronic device 103 based at least in part on the second advertising signal, and the other electronic device 102 registering to the external electronic device 103 by transmitting information regarding the other electronic device 102 to the external electronic device 103 based on the request.

For example, the electronic device 101 may register the other electronic device 102 to the external electronic device 103, in response to receiving the second advertising signal. For example, information regarding a location of the other electronic device 102 may be stored in the external electronic device 103 through the registration. The registration will be exemplified in more detail below.

For example, the electronic device 101 may, in response to the registration, provide information for informing that the other electronic device 102 is registered. For example, the information may be outputted through a speaker of the electronic device 101 or a speaker of another device (e.g., earbuds) connected to the electronic device 101. For example, when the information is outputted through the speaker of the other device, the electronic device 101 may, in response to the registration, transmit, to the other device, a signal indicating that the other electronic device 102 is registered. The other device may, based on the signal, output the information through the speaker of the other device. For example, the information may be provided through an actuator of the electronic device 101 for providing a vibration notification. For example, the information may be displayed through a display of the electronic device 101. The information displayed through the display may be exemplified through FIG. 2C.

FIG. 2C illustrates an example of information for informing that another electronic device is registered according to an embodiment of the disclosure.

Referring to FIG. 2C, the electronic device 101 may, in response to the registration, display information 250 for informing or guiding that the other electronic device 102 is registered, using a display of the electronic device 101. For example, in order to indicate that the other electronic device 102 is registered, the information 250 may include a visual object 270 having a shape corresponding to an exterior of the other electronic device 102 and text 280 for informing the registration. For example, the information 250 may further indicate the other electronic device 102, using the text 260. For example, the text 260 may be obtained through the connection with the other electronic device 102, obtained through the reception of the first advertising signal, or obtained through the reception of the second advertising signal. For example, the electronic device 101 may obtain data related to the information 250 from the external electronic device 103 through registering the other electronic device 102 to the external electronic device 103. However, it is not limited thereto. For example, the information 250 may be provided through a notification, a message, or a pop-up window. However, it is not limited thereto.

Referring to FIG. 2A, the electronic device 101 may, based on the registration, transmit, to the other electronic device 102, a signal indicating that the registration is complete. For example, the signal may include information for connecting to at least one of the external electronic device 103 or at least one other external electronic device linked with the external electronic device 103. For example, the other electronic device 102 may receive the signal from the electronic device 101. For example, the other electronic device 102 may, based on the signal, connect to at least one of the external electronic device 103 or the at least one other external electronic device.

The transmission of the signal may be replaced with another operation. For example, the external electronic device 103 may, in response to registering the other electronic device 102, transmit, to the other electronic device 102, a signal indicating that the registration is complete. For example, the signal transmitted from the external electronic device 103 to the other electronic device 102 may include information for connecting to at least one of the external electronic device 103 or at least one other external electronic device linked with the external electronic device 103.

As described above, the electronic device 101 may register, based on the reception of the first advertising signal and the second advertising signal, the other electronic device 102 to the external electronic device 103. For example, since the first advertising signal guides a reception of the second advertising signal and the second advertising signal is received by the electronic device 101 adjacent to the other electronic device 102, the registration of the other electronic device 102 through the electronic device 101 may provide enhanced security. For example, since the reception of the first advertising signal and the reception of the second advertising signal may reduce the number of user inputs (e.g., touch inputs on a display for inputting information for registering the other electronic device 102) to the electronic device 101, the registration of the other electronic device 102 through the electronic device 101 may provide an enhanced user experience. For example, since the reception of the first advertising signal and the reception of the second advertising signal are processing of a broadcast signal, the registration of the other electronic device 102 through the electronic device 101 may be executed with a relatively small load. For example, since the reception of the first advertising signal and the reception of the second advertising signal are processing of broadcast signals, the amount of heat generated from the electronic device 101 and the amount of heat generated from the other electronic device 102 while the registration of the other electronic device 102 through the electronic device 101 is executed may be relatively small.

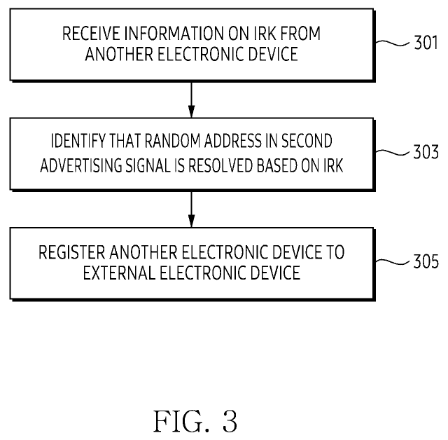

FIG. 3 illustrates a method of registering another electronic device based on an identity resolving key (IRK) according to an embodiment of the disclosure. For example, the method may be associated with at least a portion of operations exemplified through the descriptions of FIGS. 2A to 2C. However, it is not limited thereto.

Referring to FIG. 3, in operation 301, the electronic device 101 may receive information on an identity resolving key (IRK) from the other electronic device 102, through the connection with the other electronic device 102. For example, the information may be transmitted from the other electronic device 102 before the second advertising signal is broadcasted from the other electronic device 102. For example, the information may be received from the other electronic device 102 before the second advertising signal is broadcasted from the other electronic device 102. For example, the information may be received before operation 211 is executed. For example, the information may be received before operation 213 is executed.

For example, the IRK may be a key used to obtain a random address (e.g., a random medium access control (MAC) address or a resolvable private address (RPA)) included in the second advertising signal.

In operation 303, the electronic device 101 may identify that the random address in the second advertising signal received in operation 211 is resolved based on the IRK. For example, the electronic device 101 may obtain, in response to the reception of the second advertising signal, the random address from the second advertising signal. For example, the electronic device 101 may identify whether the random address is resolved using the IRK. For example, the electronic device 101 may identify that the second advertising signal is a signal broadcasted from the other electronic device 102 transmitting the first advertising signal, based on the random address being resolved using the IRK. For example, the electronic device 101 may recognize that the first advertising signal and the second advertising signal are signals broadcasted from the same device (e.g., the other electronic device 102), based on resolving of the random address through the IRK.

In operation 305, the electronic device 101 may register the other electronic device 102 to the external electronic device 103, based on the identification. For example, operation 305 may correspond to operation 215.

As described above, the electronic device 101 may, based on the resolving of the random address through the IRK, enhance security of the registration of the other electronic device 102 through the electronic device 101.

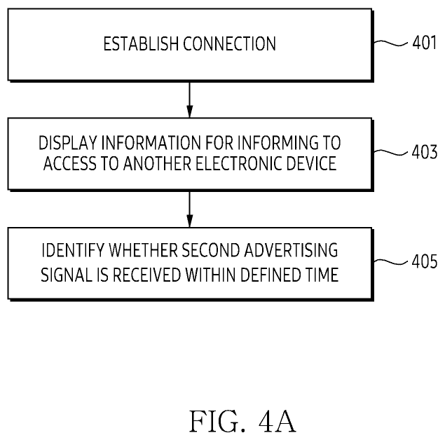

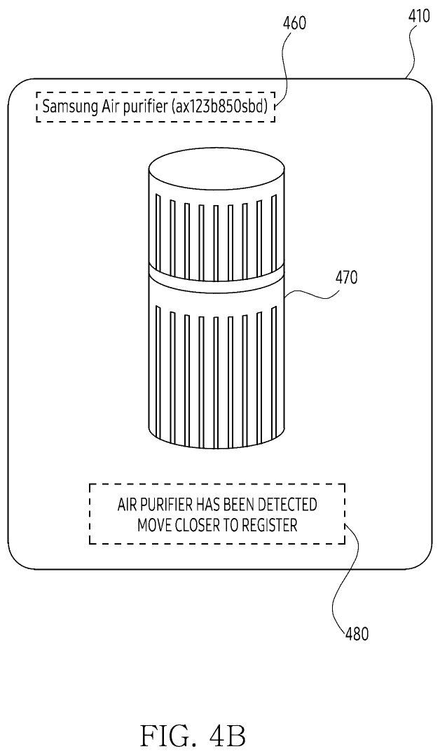

FIG. 4A illustrates a method for displaying information for informing to access to another electronic device according to an embodiment of the disclosure. For example, the method may be associated with at least a portion of operations exemplified through FIGS. 2A through 2C and 3. However, it is not limited thereto.

Referring to FIG. 4A, in operation 401, the electronic device 101 may establish the connection with the other electronic device 102. For example, operation 401 may correspond to operation 209 of FIG. 2A.

In operation 403, the electronic device 101 may, in response to the connection, display information for informing to access to the other electronic device 102. The information may be exemplified through FIG. 4B.

FIG. 4B illustrates a method for displaying information for informing to access to another electronic device according to an embodiment of the disclosure.

Referring to FIG. 4B, the electronic device 101 may, in response to the connection, display information 410 for informing or guiding to access to the other electronic device 102. For example, in order to indicate that the device which the electronic device 101 (or a user (e.g., the user 190) should access is the other electronic device 102, the information 410 may include a visual object 470 having a shape corresponding to an exterior of the other electronic device 102 and text 480 for informing to access to the other electronic device 102. For example, the information 410 may further indicate the other electronic device 102, using the text 460. For example, the text 460 may be obtained through the connection with the other electronic device 102 or may be obtained through the reception of the first advertising signal. However, it is not limited thereto. For example, the information 410 may be provided through a notification, a message, or a pop-up window. However, it is not limited thereto.

For example, displaying of the information 410 may be ceased after a defined time is elapsed. For example, the defined time may correspond to a defined time exemplified in operation 405, or may be different from the defined time exemplified in operation 405. For example, displaying of the information 410 may be ceased based on receiving the second advertising signal. However, it is not limited thereto.

Although FIG. 4B illustrates an example in which the information 410 is explicitly provided, the information 410 may also be provided indirectly or implicitly through an indication displayed along an edge region of the display of the electronic device 101.

Although FIG. 4B illustrates an example in which the information 410 is provided visually, the information 410 may also be outputted through at least one of a speaker of the electronic device 101 or as vibration through an actuator of the electronic device 101.

For example, when the information 410 is provided visually, the information 410 may indicate a direction from the electronic device 101 toward the other electronic device 102, based on at least one signal received through ultra-wide band (UWB) communication. For example, the information 410 may be displayed as superimposed on a preview image displayed based on at least a portion of a plurality of images obtained through a camera of the electronic device 101. For example, the information 410 superimposed on the preview image may be an augmented reality (AR) object. However, it is not limited thereto.

Referring to FIG. 4A, the electronic device 101 may provide the information in other ways. For example, the information may be outputted through a speaker of the electronic device 101 or a speaker of another device (e.g., earbuds) connected to the electronic device 101. For example, when the information is outputted through the speaker of the other device, the electronic device 101 may, in response to the connection, transmit, to the other device, a signal for informing the information. The other device may output, based on the signal, the information through the speaker of the other device. For example, the information may be provided through an actuator of the electronic device 101 for providing a vibration notification. However, it is not limited thereto.

In operation 405, the electronic device 101 may identify whether the second advertising signal is received within a defined time, after the information is displayed. For example, since the other electronic device 102 continuously broadcasting the second advertising signal may reduce security of a registration of the other electronic device 102, the electronic device 101 may perform the identification.

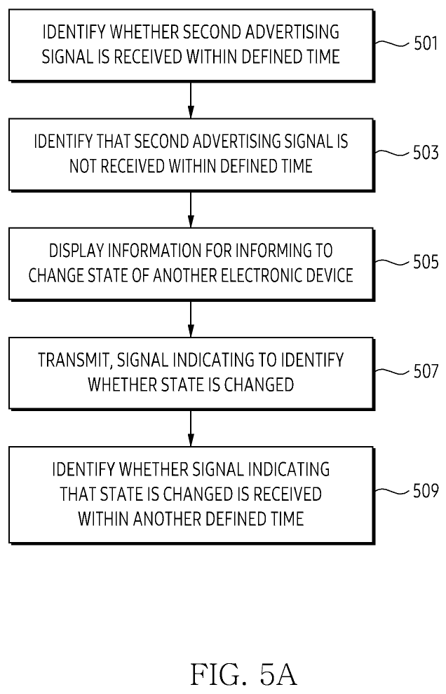

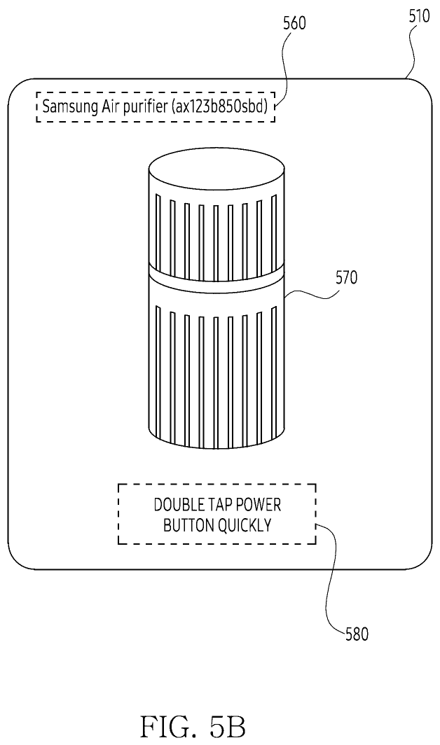

For example, the electronic device 101 may execute operation 215, based at least in part on the second advertising signal being received within the defined time. For example, the electronic device 101 may execute at least one other operation distinct from operation 215, based on identifying that the second advertising signal is not received within the defined time. The at least one other operation will be exemplified through FIGS. 5A and 5B.

Although FIGS. 4A and 4B illustrate an example in which the information is displayed in response to the connection, the information may also be displayed based on another condition. For example, the information may also be displayed in response to an execution of operation 211. However, it is not limited thereto.

As described above, the electronic device 101 may display the information to guide the reception of the second advertising signal. For example, the electronic device 101 may guide the registration of the other electronic device 102 through the display of the information. For example, the electronic device 101 may execute the registration of the other electronic device 102 according to intention of a user (e.g., the user 190) through the display of the information.

FIG. 5A illustrates a method for displaying information for informing to change a state of another electronic device according to an embodiment of the disclosure. For example, the method may be associated with at least a portion of operations exemplified through FIGS. 2A to 2C, 3, 4A, and 4B. However, it is not limited thereto.

Referring to FIG. 5A, in operation 501, the electronic device 101 may identify whether the second advertising signal is received within a defined time. For example, operation 501 may be executed after operation 211 is executed. For example, operation 501 may be executed after operation 403 is executed. However, it is not limited thereto.

In operation 503, the electronic device 101 may identify that the second advertising signal is not received within the defined time. For example, the electronic device 101 may, on a condition that the electronic device 101 is not located in an area 160 within the defined time, identify that the second advertising signal is not received within the defined time. For example, on a condition that a quality of a channel between the electronic device 101 and the other electronic device 102 is relatively low even when the electronic device 101 is located in the area 160 within the defined time, the electronic device 101 may identify that the second advertising signal is not received within the defined time. However, it is not limited thereto.

In operation 505, the electronic device 101 may display information for informing to change a state of the other electronic device 102, based on identifying that the second advertising signal is not received within the defined time. The information may be exemplified through FIG. 5B.

FIG. 5B illustrates a method for informing to change a state of another electronic device according to an embodiment of the disclosure.

Referring to FIG. 5B, the electronic device 101 may, in response to identifying that the second advertising signal is not received within the defined time, display information 510 for informing or guiding to change a state of the other electronic device 102. For example, the information 510 may include text 580 for informing or guiding a user action to change the state of the other electronic device 102. For example, when the other electronic device 102 is an air purifier that includes a power button exposed to the outside, the text 580 may inform or guide to change the state of the other electronic device 102 to a state in which the power button is touched or pressed multiple times. For another example, when the other electronic device 102 is a refrigerator, the text 580 may inform or guide to change the state of the other electronic device 102 to a state in which a door of the other electronic device 102 is open. However, it is not limited thereto.

For example, the information 510 may include text indicating the other electronic device 102. For example, the information 510 may include a visual object 570 having a shape corresponding to the exterior of the other electronic device 102. For example, the information 510 may further include text 560 that includes at least one of a type of the other electronic device 102 or identification information of the other electronic device 102. For example, the text 560 may be obtained through the connection with the other electronic device 102 or through the reception of the first advertising signal. However, it is not limited thereto.

For example, the display of the information 510 may be ceased after the defined time has elapsed. For example, the defined time may correspond to another defined time exemplified in operation 509, or may be different from another defined time exemplified in operation 509. For example, the display of the information 510 may be ceased based on receiving the second advertising signal. However, it is not limited thereto.

Referring to FIG. 5A, the electronic device 101 may provide the information in other ways. For example, the information may be outputted through a speaker of the electronic device 101 or a speaker of another device (e.g., earbuds) connected to the electronic device 101. For example, when the information is outputted through a speaker of the other device, the electronic device 101 may transmit, to the other device, a signal for informing the information, in response to the connection. The other device may output the information through the speaker of the other device, based on the signal. For example, the information may be provided through an actuator of the electronic device 101 for providing a vibration notification. However, it is not limited thereto.

In operation 507, the electronic device 101 may, based on identifying that the second advertising signal is not received within the defined time, transmit, to the other electronic device 102 through the connection with the other electronic device 102, a signal indicating to identify whether the state of the other electronic device 102 is changed. For example, the signal may be transmitted in response to identifying that the second advertising signal is not received within the defined time. For example, the signal may be transmitted in response to displaying of the information.

For example, the signal may cause the other electronic device 102 to identify or monitor the change of the state. For example, the other electronic device 102 may, in response to the signal transmitted in operation 507, monitor or identify, within a defined time, the change of the state. For example, the defined time may correspond to another defined time exemplified in operation 509, or may be different from another defined time exemplified in operation 509.

FIG. 5A illustrates an example in which operation 507 is executed after operation 505 is executed, but it is for convenience of explanation according to an embodiment of the disclosure. For example, at least a portion of operation 507 may be executed in parallel with at least a portion of operation 505. For example, operation 507 may be executed before operation 505 is executed.

In operation 509, in response to displaying the information, or transmitting the signal indicating to identify whether the state is changed, the electronic device 101 may identify whether a signal indicating that the state is changed is received within another defined time.

For example, the electronic device 101 may register the other electronic device 102 to the external electronic device 103, based on the signal received within the other defined time. For example, the electronic device 101 may cease or terminate an execution of at least one operation for registering the other electronic device 102, based on identifying that the signal is not received within the other defined time.

Although FIG. 5A illustrates an example of displaying the information in operation 505 based on identifying that the second advertising signal is not received within the defined time, operations 505 to 509 may be replaced with another operation.

For example, the electronic device 101 may provide information to inform or guide that a time for registration of the other electronic device 102 will expire based on identifying that the second advertising signal is not received within the defined time. For example, the information may be displayed through the display. For example, the information may be outputted through a speaker of the electronic device 101. For example, the information may be provided as a vibration through an actuator of the electronic device 101. However, it is not limited thereto.

As described above, on a condition that the second advertising signal is not received within the defined time, the electronic device 101 may display information for informing to change a state of the other electronic device 102. For example, the information may inform or guide a user (e.g., the user 190) to access the other electronic device 102 for the change of the state of the other electronic device 102. For example, since the electronic device 101 receiving a signal indicating the change of the state of the other electronic device 102 from the other electronic device 102 may indicate that the other electronic device 102 is authenticated or verified, the electronic device 101 may register the other electronic device 102 in response to the reception of the signal.

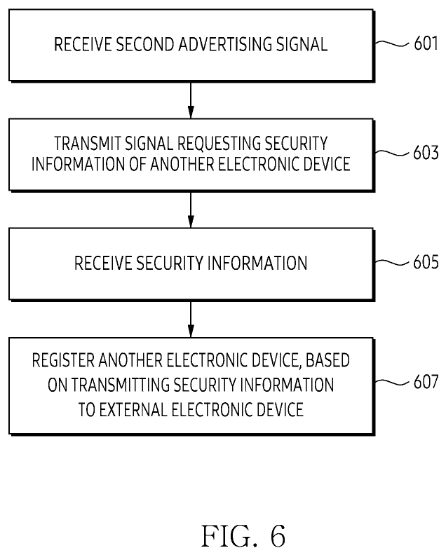

FIG. 6 illustrates a method for registering another electronic device based on security information according to an embodiment of the disclosure. For example, the method may be associated with at least a portion of operations exemplified through FIGS. 2A to 2C, 3, 4A, 4B, 5A, and 5B. However, it is not limited thereto.

Referring to FIG. 6, in operation 601, the electronic device 101 may receive the second advertising signal from the other electronic device 102. For example, operation 601 may correspond to operation 213 of FIG. 2A.

In operation 603, in response to the reception of the second advertising signal, the electronic device 101 may transmit a signal requesting security information (e.g., identification information of the other electronic device 102) of the other electronic device 102 through the connection with the other electronic device 102. For example, the security information may be information used in the external electronic device 103 to authenticate, verify, or register the other electronic device 102. For example, the security information may include at least one of a public MAC address, or a serial number of the other electronic device 102.

In the device 605, the electronic device 101 may receive the security information from the other electronic device 102 through the connection.

In operation 607, the electronic device 101 may register the other electronic device 102, based on transmitting the security information to the external electronic device 103. For example, wireless communication circuitry of the electronic device 101 used to transmit the security information may be different from wireless communication circuitry of the electronic device 101 used to execute the operations exemplified above. For example, wireless communication circuitry used for communication between the electronic device 101 and the other electronic device 102 may be different from wireless communication circuitry used for communication between the electronic device 101 and the external electronic device 103.

For example, the electronic device 101 may receive, from the external electronic device, a signal indicating that the other electronic device 102 is authenticated based on the security information. For example, the electronic device 101 may register the other electronic device 102 to the external electronic device 103, based on the signal.

As described above, the electronic device 101 may register the other electronic device 102 to the external electronic device 103, based on reception of the second advertising signal.

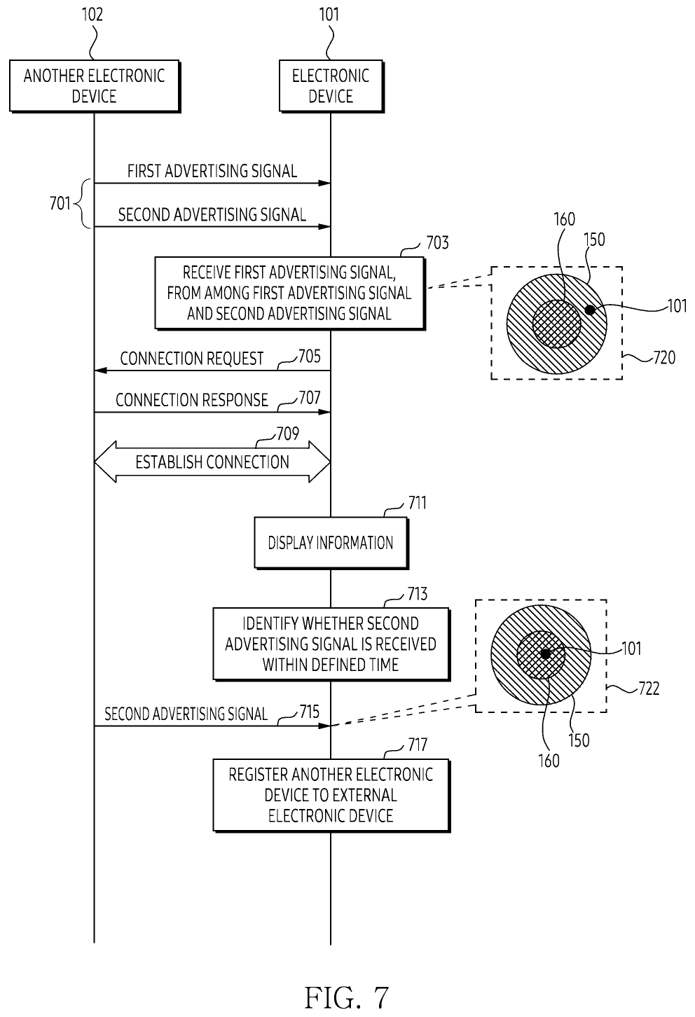

FIG. 7 illustrates a method for registering another electronic device, using a connection established based on a first advertising signal according to an embodiment of the disclosure. For example, the method may be associated with at least a portion of operations exemplified through FIGS. 3, 4A, 4B, 5A, 5B, and 6. However, it is not limited thereto.

Referring to FIG. 7, in operation 701, the other electronic device 102 may broadcast the first advertising signal with the first Tx power and broadcast the second advertising signal with the second Tx power. For example, a time interval during which the first advertising signal is transmitted may at least partially overlap with a time interval during which the second advertising signal is transmitted. For example, the other electronic device 102 may alternately broadcast the first advertising signal and the second advertising signal. However, it is not limited thereto. For example, the first advertising signal and the second advertising signal may correspond to the first advertising signal and the second advertising signal exemplified through FIGS. 2A to 2C, 3, 4A, 4B, 5A, 5B, and 6.

In operation 703, the electronic device 101 may receive the first advertising signal from among the first advertising signal and the second advertising signal. For example, the electronic device 101 may receive the first advertising signal, on a condition of being located within an area 150 and outside an area 160 as in a state 720. For example, a reception strength of the first advertising signal may be greater than the reference reception strength.

In operation 705, the electronic device 101 may transmit, to the other electronic device 102, a connection request, based on the reception strength of the first advertising signal greater than the reference reception strength. For example, the other electronic device 102 may receive the connection request from the electronic device 101.

In operation 707, in response to the connection request, the other electronic device 102 may transmit, to the electronic device 101, a connection response. For example, the electronic device 101 may receive the connection response from the other electronic device 102.

In operation 709, the electronic device 101 and the other electronic device 102 may establish a connection between the electronic device 101 and the other electronic device 102, based on at least one of the connection request or the connection response.

In operation 711, in response to the connection, the electronic device 101 may display information for informing to access to the other electronic device 102. For example, operation 711 may correspond to operation 403 of FIG. 4A.

In operation 713, the electronic device 101 may identify whether the second advertising signal is received within a defined time. For example, operation 713 may correspond to operation 405 of FIG. 4A.

In operation 715, the electronic device 101 may receive the second advertising signal broadcasted from the other electronic device 102.

For example, the electronic device 101 may be moved after the first advertising signal is received. For example, the electronic device 101 may be located within the area 160 according to the movement, as in the state 722. For example, the electronic device 101 may be located within the area 160 according to movement of a user (e.g., the user 190) recognizing the information. The electronic device 101 located within the area 160 may receive the second advertising signal. For example, the second advertising signal may be received within the defined time.

In operation 717, the electronic device 101 may register the other electronic device 102 to the external electronic device 103, based at least in part on the second advertising signal received within the defined time. For example, operation 717 may correspond to operation 215 of FIG. 2A.

As described above, on a condition that a time interval during which the first advertising signal is broadcasted overlaps at least partially with a time interval during which the second advertising signal is broadcasted, the electronic device 101 may provide a service for registering the other electronic device 102 to the external electronic device 103 through the electronic device 101, based on receiving of the first advertising signal and the second advertising signal.

FIG. 7 includes operation 711, but this is for convenience of explanation. For example, the electronic device 101 may bypass or refrain from executing operation 711 and execute operation 713.

Although not illustrated in FIG. 7, in an embodiment, the electronic device 101 may register the other electronic device 102 to the external electronic device 103 as in operation 717, on a condition that the second advertising signal is received before the first advertising signal is received. In other an embodiment, the electronic device 101 may ignore the second advertising signal, on a condition that the second advertising signal is received before the first advertising signal is received. For example, ignoring the second advertising signal may indicate refraining from or bypassing registering the other electronic device 102 to the external electronic device 103, as in operation 717, based on the second advertising signal. However, it is not limited thereto.

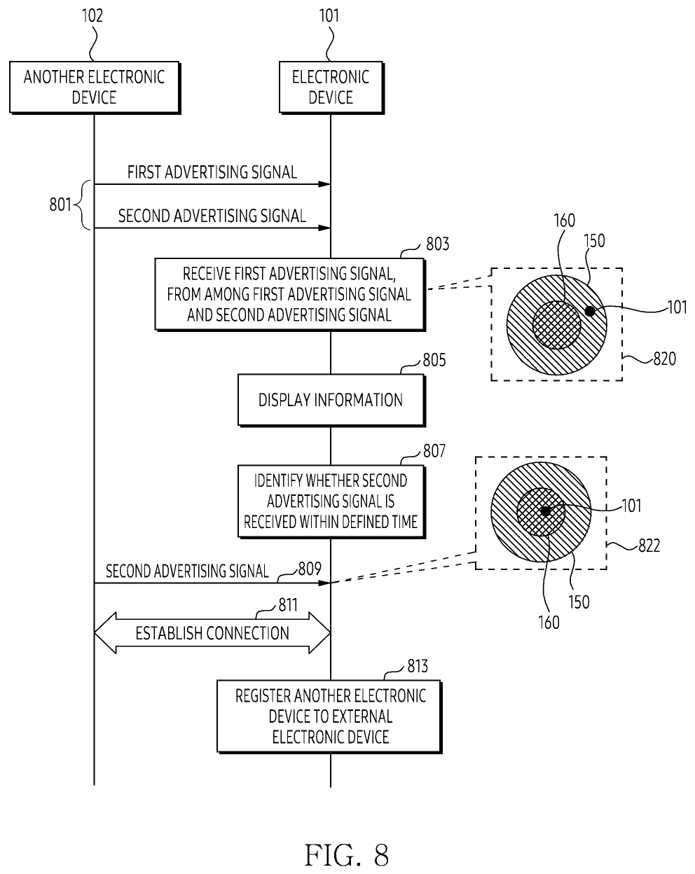

FIG. 8 illustrates a method for registering another electronic device, using a connection established based on a second advertising signal according to an embodiment of the disclosure. For example, the method may be associated with at least a portion of operations exemplified through FIGS. 3, 4A, 4B, 5A, 5B, and 6. However, it is not limited thereto.

Referring to FIG. 8, in operation 801, the other electronic device 102 may broadcast the first advertising signal with the first Tx power and broadcast the second advertising signal with the second Tx power. For example, a time interval during which the first advertising signal is transmitted may at least partially overlap with a time interval during which the second advertising signal is transmitted. For example, the other electronic device 102 may alternately broadcast the first advertising signal and the second advertising signal. However, it is not limited thereto. For example, the first advertising signal and the second advertising signal may correspond to the first advertising signal and the second advertising signal exemplified through FIGS. 2A to 2C, 3, 4A, 4B, 5A, 5B, 6, and 7.

In operation 803, the electronic device 101 may receive the first advertising signal among the first advertising signal and the second advertising signal. For example, the electronic device 101 may receive the first advertising signal on a condition of being located within an area 150 and outside an area 160, as in a state 820. For example, a reception strength of the first advertising signal may be greater than the reference reception strength.

In operation 805, the electronic device 101 may display information for informing to access to the other electronic device 102, based on the reception strength of the first advertising signal being greater than the reference reception strength. For example, operation 805 may correspond to operation 403 of FIG. 4A or operation 711 of FIG. 7.

In operation 807, the electronic device 101 may identify whether the second advertising signal is received within a defined time. For example, operation 713 may correspond to operation 405 of FIG. 4A or operation 713 of FIG. 7.

In operation 809, the electronic device 101 may receive the second advertising signal broadcasted from the other electronic device 102.

For example, the electronic device 101 may be moved after the first advertising signal is received. For example, the electronic device 101 may be located within the area 160 according to the movement, as in the state 822. For example, the electronic device 101 may be located within the area 160 according to movement of a user (e.g., the user 190) recognizing the information. The electronic device 101 located within the area 160 may receive the second advertising signal. For example, the second advertising signal may be received within the defined time.

In operation 811, the electronic device 101 may establish a connection with the other electronic device 102, based on the second advertising signal received within the defined time. For example, in response to the second advertising signal received within the defined time, the electronic device 101 may transmit, to the other electronic device 102, a connection request. For example, the other electronic device 102 may receive the connection request from the electronic device 101. For example, in response to the connection request, the other electronic device 102 may transmit, to the electronic device 101, a connection response. For example, the electronic device 101 may receive the connection response from the other electronic device 102. For example, the electronic device 101 and the other electronic device 102 may establish the connection, based on at least one of the connection request or the connection response.

In operation 813, the electronic device 101 may register the other electronic device 102 to the external electronic device 103, based at least in part on the establishment of the connection. For example, the electronic device 101 may request security information from the other electronic device 102, through the connection. For example, the electronic device 101 may receive the security information from the other electronic device 102 through the connection. For example, the electronic device 101 may register the other electronic device 102, based on the security information. For example, operation 813 may correspond to operation 215 of FIG. 2A or operation 717 of FIG. 7.

As described above, on a condition that a time interval during which the first advertising signal is broadcasted overlaps at least partially with a time interval during which the second advertising signal is broadcasted, the electronic device 101 may provide a service for registering the other electronic device 102 to the external electronic device 103 through the electronic device 101, based on receiving of the first advertising signal and the second advertising signal.

FIG. 8 includes operation 805, but this is for convenience of explanation. For example, the electronic device 101 may bypass or refrain from executing operation 805, and execute operation 807.

Although not illustrated in FIG. 8, in an embodiment, the electronic device 101 may register the other electronic device 102 to the external electronic device 103 as in operation 813, on a condition that the second advertising signal is received before the first advertising signal is received. In another embodiment, the electronic device 101 may ignore the second advertising signal on a condition that the second advertising signal is received before the first advertising signal is received. For example, ignoring the second advertising signal may indicate refraining from or bypassing registering the other electronic device 102 to the external electronic device 103, as in operation 813, based on the second advertising signal. However, it is not limited thereto.

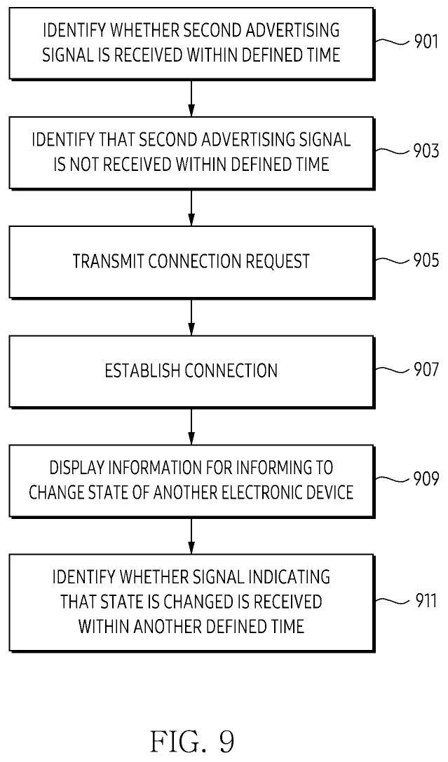

FIG. 9 illustrates a method for displaying information for informing to change a state of another electronic device, based on a connection request transmitted based on a first advertising signal according to an embodiment of the disclosure. For example, the method may be associated with at least a portion of operations exemplified through FIG. 8. However, it is not limited thereto.

Referring to FIG. 9, in operation 901, the electronic device 101 may identify whether the second advertising signal is received within a defined time. For example, operation 901 may correspond to operation 807 of FIG. 8.

In operation 903, the electronic device 101 may identify that the second advertising signal is not received within the defined time. For example, the electronic device 101 may identify that the second advertising signal is not received within the defined time, on a condition that the electronic device 101 is not located within the area 160 within the defined time. For example, the electronic device 101 may identify that the second advertising signal is not received within the defined time, on a condition that a quality of a channel between the electronic device 101 and the other electronic device 102 is relatively low even when the electronic device 101 is located within the area 160 within the defined time. However, it is not limited thereto.

In operation 905, the electronic device 101 may transmit, to the other electronic device 102, a connection request. For example, the connection request may be transmitted based on the first advertising signal. For example, the other electronic device 102 may receive the connection request from the electronic device 101.

In operation 907, the electronic device 101 may establish the connection with the other electronic device 102, based at least in part on the connection request. For example, the other electronic device 102 may transmit, to the electronic device 101, a connection response, in response to the connection request. For example, the electronic device 101 may receive the connection response. For example, the electronic device 101 and the other electronic device 102 may establish the connection based on at least one of the connection request or the connection response.

In operation 909, the electronic device 101 may display information for informing to change a state of the other electronic device 102, based on the connection. For example, operation 909 may correspond to operation 505 of FIG. 5A. For example, the electronic device 101 may transmit, to the other electronic device 102, a signal indicating to identify whether the state is changed, based on the connection. For example, transmitting the signal may correspond to operation 507 of FIG. 5A.

In operation 911, the electronic device 101 may identify whether a signal indicating that the state is changed is received within another defined time, in response to displaying the information for informing to change the state or transmitting the signal indicating to identify whether the state is changed. For example, operation 911 may correspond to operation 509 of FIG. 5A.

As described above, when the second advertising signal is not received, the electronic device 101 may establish the connection with the other electronic device 102, based on the received first advertising signal, unlike the second advertising signal. The electronic device 101 may register the other electronic device 102 to the external electronic device 103, by displaying the information, in response to the connection.

Although the descriptions illustrate operations executed by the electronic device 101 and the other electronic device 102, the operations may also be executed by components (e.g., processor) of each of the electronic device 101 and the other electronic device 102.

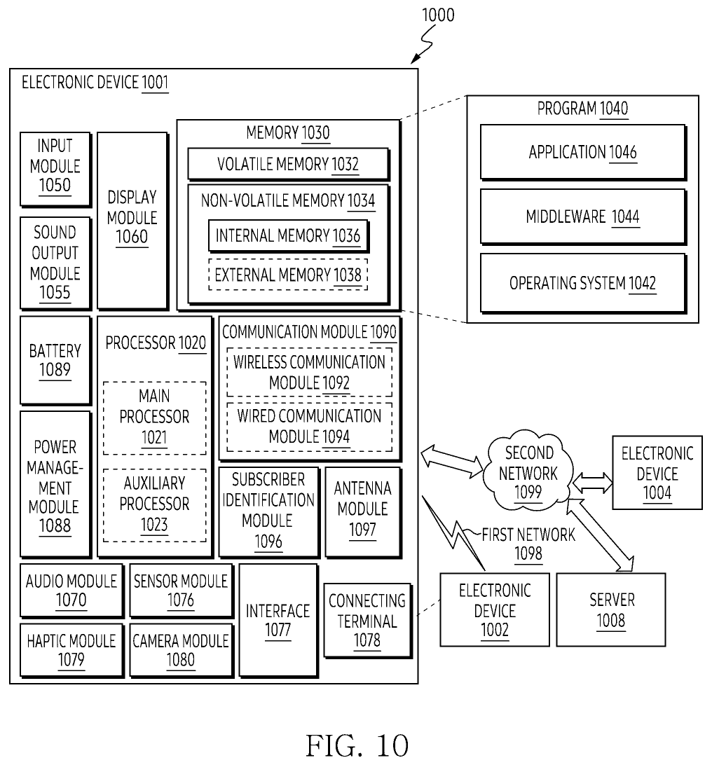

FIG. 10 is a block diagram illustrating an electronic device 1001 in a network environment 1000 according to an embodiment of the disclosure.

Referring to FIG. 10, the electronic device 1001 in the network environment 1000 may communicate with an electronic device 1002 via a first network 1098 (e.g., a short-range wireless communication network), or at least one of an electronic device 1004 or a server 1008 via a second network 1099 (e.g., a long-range wireless communication network). According to an embodiment, the electronic device 1001 may communicate with the electronic device 1004 via the server 1008. According to an embodiment, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In some embodiments, at least one of the components (e.g., the connecting terminal 1078) may be omitted from the electronic device 1001, or one or more other components may be added in the electronic device 1001. In some embodiments, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to an embodiment, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., sleep) state, or together with the main processor 1021 while the main processor 1021 is in an active state (e.g., executing an application). According to an embodiment, the auxiliary processor 1023 (e.g., an image signal processor or a communication processor) may be implemented as part of another component (e.g., the camera module 1080 or the communication module 1090) functionally related to the auxiliary processor 1023. According to an embodiment, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment, the display module 1060 may include a touch sensor adapted to detect a touch, or a pressure sensor adapted to measure the intensity of force incurred by the touch.

The audio module 1070 may convert a sound into an electrical signal and vice versa. According to an embodiment, the audio module 1070 may obtain the sound via the input module 1050, or output the sound via the sound output module 1055 or a headphone of an external electronic device (e.g., an electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the electronic device 1002) directly (e.g., wiredly) or wirelessly. According to an embodiment, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the electronic device 1002). According to an embodiment, the connecting terminal 1078 may include, for example, an HDMI connector, a USB connector, a SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment, the haptic module 1079 may include, for example, a motor, a piezoelectric element, or an electric stimulator.

The camera module 1080 may capture a still image or moving images. According to an embodiment, the camera module 1080 may include one or more lenses, image sensors, image signal processors, or flashes.

The power management module 1088 may manage power supplied to the electronic device 1001. According to an embodiment, the power management module 1088 may be implemented as at least part of, for example, a power management integrated circuit (PMIC).

The battery 1089 may supply power to at least one component of the electronic device 1001. According to an embodiment, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the electronic device 1002, the electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the millimeter wave (mmWave) band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the electronic device 1004), or a network system (e.g., the second network 1099). According to an embodiment, the wireless communication module 1092 may support a peak data rate (e.g., 20 Gbps or more) for implementing eMBB, loss coverage (e.g., 1064 dB or less) for implementing mMTC, or U-plane latency (e.g., 0.5 ms or less for each of downlink (DL) and uplink (UL), or a round trip of 10 ms or less) for implementing URLLC.

The antenna module 1097 may transmit or receive a signal or power to or from the outside (e.g., the external electronic device) of the electronic device 1001. According to an embodiment, the antenna module 1097 may include an antenna including a radiating element composed of a conductive material or a conductive pattern formed in or on a substrate (e.g., a printed circuit board (PCB)). According to an embodiment, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment, another component (e.g., a radio frequency integrated circuit (RFIC)) other than the radiating element may be additionally formed as part of the antenna module 1097.

According to various embodiments, the antenna module 1097 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1001 and the external electronic device 1004 via the server 1008 coupled with the second network 1099. Each of the electronic devices 1002 or 1004 may be a device of a same type as, or a different type, from the electronic device 1001. According to an embodiment, all or some of operations to be executed at the electronic device 1001 may be executed at one or more of the external electronic devices 1002 or 1004, or the server 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment, the external electronic device 1004 may include an internet-of-things (IoT) device. The server 1008 may be an intelligent server using at least one of machine learning or a neural network. According to an embodiment, the external electronic device 1004 or the server 1008 may be included in the second network 1099. The electronic device 1001 may be applied to intelligent services (e.g., smart home, smart city, smart car, or healthcare) based on 5G communication technology or IoT-related technology.

As described above, an electronic device 101 may comprise wireless communication circuitry (e.g., the wireless communication module 1094) and a processor (e.g., the processor 1020). According to an embodiment, the processor may be configured to, receive a first advertising signal broadcasted from another electronic device 102, using the wireless communication circuitry. According to an embodiment, the processor may be configured to, based on a reception strength of the first advertising signal greater than a reference reception strength, transmit, to the another electronic device 102, a connection request, using the wireless communication circuitry. According to an embodiment, the processor may be configured to, based at least in part on a connection with the another electronic device 102 established based at least in part on the connection request, receive the second advertising signal broadcasted with a second transmit (Tx) power lower than a first Tx power of the first advertising signal from the another electronic device 102, using the wireless communication circuitry. According to an embodiment, the processor may be configured to, based at least in part on the reception of the second advertising signal, register the another electronic device 102 to an external electronic device 103.

According to an embodiment, the processor may be configured to, receive information regarding an identity resolving key (IRK) from the another electronic device 102, via the connection, using the wireless communication circuitry. According to an embodiment, the processor may be configured to, based at least in part on identifying that a random address in the received second advertising packet is resolved based on the IRK, register the another electronic device 102 to the external electronic device 103.

The electronic device 101 may comprise a display (e.g., the display module 1060). According to an embodiment, the processor may be configured to, based on establishing of the connection, display information for informing to access to the another electronic device 102, using the display. According to an embodiment, displaying of the information may be ceased based on identifying that a defined time is elapsed from a timing at which the information is displayed or receiving the second advertising signal.

The electronic device 101 may comprise another wireless communication circuitry. According to an embodiment, the processor may be configured to, in response to the reception of the second advertising signal, transmit a signal requesting security information of the another electronic device 102, via the connection, using the wireless communication circuitry. According to an embodiment, the processor may be configured to receive the security information from the another electronic device 102, via the connection, using the wireless communication circuitry. According to an embodiment, the processor may be configured to, based on transmitting the security information to the external electronic device 103 using the another wireless communication circuitry, register the another electronic device 102 to the external electronic device 103.

According to an embodiment, the processor may be configured to receive, from the external electronic device 103, a signal indicating that the another electronic device 102 is authenticated based on the security information, using the another wireless communication circuitry. According to an embodiment, the processor may be configured to, based on the signal indicating that the another electronic device 102 is authenticated, register the another electronic device 102 to the external electronic device 103.

The electronic device 101 may comprise a display (e.g., the display module 1060).

According to an embodiment, the processor may be configured to identify whether the second advertising signal is received within a defined time. According to an embodiment, the processor may be configured to, based at least in part on identifying that the second advertising signal is received within the defined time, register the another electronic device 102 to the external electronic device 103. According to an embodiment, the processor may be configured to, based at least in part on identifying that the second advertising signal is not received within the defined time, display information for informing to change a state of the another electronic device 102, using the display, and transmit, to the another electronic device 102, a signal indicating to identify whether the state is changed via the connection using the wireless communication circuitry. According to an embodiment, the processor may be configured to, in response to displaying of the information or transmitting of the signal indicating to identify whether the state is changed, identify whether a signal indicating that the state is changed is received from the another electronic device 102 within another defined time. According to an embodiment, the processor may be configured to, based at least in part on identifying that the signal indicating that the state is changed is received from the another electronic device 102 within the another defined time, register the another electronic device 102 to the external electronic device 103.

According to an embodiment, the processor may be configured to, based on registering of the another electronic device 102, display information for informing that the another electronic device 102 is registered, using the display.

As described above, an electronic device 101 may comprise a display (e.g., the display module 1060), wireless communication circuitry (e.g., the wireless communication module 1092), and a processor (e.g., the processor 1020). According to an embodiment, the processor may be configured to receive a first advertising signal broadcasted from another electronic device 102 with a first Tx power from among the first advertising signal and a second advertising signal broadcasted from the another electronic device 102 with a second Tx power lower than the first Tx power, using the wireless communication circuitry. According to an embodiment, the processor may be configured to, based on a reception strength of the first advertising signal greater than a reference reception strength, transmit, to the another electronic device 102, a connection request, using the wireless communication circuitry. According to an embodiment, the processor may be configured to, in response to a connection with the another electronic device 102 established based at least in part on the connection request, display information for informing to access to the another electronic device 102, and identify whether the second advertising signal is received within a defined time. According to an embodiment, the processor may be configured to, based at least in part on the second advertising signal received within the defined time, register the another electronic device 102 to the external electronic device 103.

According to an embodiment, the processor may be configured to receive, from the another electronic device 102 through the connection, information regarding an identity resolving key (IRK), using the wireless communication circuitry. According to an embodiment, the processor may be configured to register the another electronic device 102 to the external electronic device 103, based at least in part on identifying that a random address in the second advertising signal received within the defined time is resolved based on the IRK.

According to an embodiment, the electronic device 101 may include another wireless communication circuitry. According to an embodiment, the processor may be configured to, in response to the second advertising signal received within the defined time, transmit a signal requesting security information of the another electronic device 102, through the connection, using the wireless communication circuitry. According to an embodiment, the processor may be configured to receive, from the another electronic device 102 through the connection, the security information, using the wireless communication circuitry. According to an embodiment, the processor may be configured to register the another electronic device 102 to the external electronic device 103, based on transmitting the security information to the external electronic device 103 using the another wireless communication circuitry.

According to an embodiment, the processor may be configured to receive, from the external electronic device 103, a signal indicating that the another electronic device 102 is authenticated based on the security information, using the another wireless communication circuitry. According to an embodiment, the processor may be configured to register the another electronic device 102 to the external electronic device 103, based on the signal indicating that the another electronic device 102 is authenticated.

According to an embodiment, the processor may be configured to, based on identifying that the second advertising signal is not received within the defined time, display information for informing to change a state of the another electronic device 102 using the display, and transmit, to the another electronic device 102, a signal indicating to identify whether the state is changed, through the connection using the wireless communication circuitry.

According to an embodiment, the processor may be configured to, in response to displaying of the information for informing to change the state or transmitting of the signal indicating to identify whether the state is changed, identify whether a signal indicating that the state is changed is received from the another electronic device 102 within another defined time.

According to an embodiment, the processor may be configured to register the another electronic device 102 to the external electronic device 103, based at least in part on identifying that the signal indicating that the state is changed is received from the another electronic device 102 within the another defined time.

According to an embodiment, the processor may be configured to, based on registering of the another electronic device 102, display information for informing that the another electronic device 102 is registered, using the display.

According to an embodiment, the processor may be configured to establish the connection based at least in part on receiving a connection response transmitted from the another electronic device 102 in response to the connection request.

As described above, an electronic device 101 may include a display (e.g., the display module 1060), wireless communication circuitry (e.g., the wireless communication module 1092), and a processor (e.g., the processor 1020). According to an embodiment, the processor may be configured to receive a first advertising signal broadcasted from another electronic device 102 with a first Tx power from among the first advertising signal and a second advertising signal broadcasted from the another electronic device 102 with a second Tx power lower than the first Tx power, using the wireless communication circuitry. According to an embodiment, the processor may be configured to, based on a reception strength of the first advertising signal greater than a reference reception strength, display information for informing to access to the another electronic device 102, using the display, and identify whether the second advertising signal is received within a defined time. According to an embodiment, the processor may be configured to establish a connection with the another electronic device 102, based on the second advertising signal received within the defined time. According to an embodiment, the processor may be configured to register the another electronic device 102 to the external electronic device 103, based at least in part on establishing of the connection.

According to an embodiment, the electronic device 101 may include another wireless communication circuitry. According to an embodiment, the processor may be configured to transmit a signal requesting security information of the another electronic device 102, through the connection, using the wireless communication circuitry. According to an embodiment, the processor may be configured to receive, from the another electronic device 102 through the connection, the security information, using the wireless communication circuitry. According to an embodiment, the processor may be configured to register the another electronic device 102 to the external electronic device 103, based on transmitting the security information to the external electronic device 103 using the another wireless communication circuitry.

According to an embodiment, the processor may be configured to receive, from the external electronic device 103, a signal indicating that the another electronic device 102 is authenticated based on the security information, using the another wireless communication circuitry. According to an embodiment, the processor may be configured to register the another electronic device 102 to the external electronic device 103, based on the signal indicating that the another electronic device 102 is authenticated.

According to an embodiment, the processor may be configured to, based on identifying that the second advertising signal is not received within the defined time, transmit, to the another electronic device 102, a connection request, using the wireless communication circuitry. According to an embodiment, the processor may be configured to, based on the connection established based at least in part on the connection request, display information for informing to change a state of the another electronic device 102, using the display, and transmit, to the another electronic device 102, a signal indicating to identify whether the state is changed through the connection by using the wireless communication circuitry. According to an embodiment, the processor may be configured to, in response to displaying of the information for informing to change the state or transmitting of the signal indicating to identify whether the state is changed, identify whether a signal indicating that the state is changed is received from the another electronic device 102 within another defined time. According to an embodiment, the processor may be configured to register the another electronic device 102 to the external electronic device 103, based at least in part on identifying that the signal indicating that the state is changed is received from the another electronic device 102 within the another defined time.

According to an embodiment, the processor may be configured to display information for informing that the another electronic device 102 is registered using the display, based on registering of the another electronic device 102.

According to an embodiment, the processor may be configured to, in response to the second advertising signal received within the defined time, transmit, to the external electronic device 103, a connection request, using the wireless communication circuitry. According to an embodiment, the processor may be configured to establish the connection based at least in part on receiving a connection response transmitted from the another electronic device 102 in response to the connection request.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
wireless communication circuitry;
at least one processor comprising processing circuitry; and
memory comprising one or more storage media storing instructions,
wherein the instructions, when executed by the at least one processor individually or collectively, cause the electronic device to:
receive a first advertising signal broadcasted from another electronic device, using the wireless communication circuitry,
based on a reception strength of the first advertising signal greater than a reference reception strength, transmit, to the other electronic device, a connection request, using the wireless communication circuitry,
based at least in part on a connection with the other electronic device established based at least in part on the connection request, receive a second advertising signal broadcasted with a second transmit (Tx) power lower than a first Tx power of the first advertising signal from the other electronic device, using the wireless communication circuitry, and
based at least in part on the reception of the second advertising signal, register the other electronic device to an external electronic device.

2. The electronic device of claim 1, wherein the instructions, when executed by the at least one processor individually or collectively, further cause the electronic device to:
receive information regarding an identity resolving key (IRK) from the other electronic device, via the connection, using the wireless communication circuitry; and
based at least in part on identifying that a random address in the received second advertising packet is resolved based on the IRK, register the other electronic device to the external electronic device.

3. The electronic device of claim 1, further comprising:
a display,
wherein the instructions, when executed by the at least one processor individually or collectively, further cause the electronic device to, based on establishing of the connection, display information for informing to access to the other electronic device, using the display, and
wherein displaying of the information is ceased based on identifying that a defined time is elapsed from a timing at which the information is displayed or receiving the second advertising signal.

4. The electronic device of claim 1, further comprising:
another wireless communication circuitry,
wherein the instructions, when executed by the at least one processor individually or collectively, further cause the electronic device to:
in response to the reception of the second advertising signal, transmit a signal requesting security information of the other electronic device, via the connection, using the wireless communication circuitry,
receive the security information from the other electronic device, via the connection, using the wireless communication circuitry, and
based on transmitting the security information to the external electronic device using the another wireless communication circuitry, register the other electronic device to the external electronic device.

5. The electronic device of claim 4, wherein the instructions, when executed by the at least one processor individually or collectively, further cause the electronic device to:
receive, from the external electronic device, a signal indicating that the other electronic device is authenticated based on the security information, using the other wireless communication circuitry, and
based on the signal indicating that the other electronic device is authenticated, register the other electronic device to the external electronic device.

6. The electronic device of claim 1, further comprising:
a display,
wherein the instructions, when executed by the at least one processor individually or collectively, further cause the electronic device to:
identify whether the second advertising signal is received within a defined time,
based at least in part on identifying that the second advertising signal is received within the defined time, register the other electronic device to the external electronic device,
based at least in part on identifying that the second advertising signal is not received within the defined time:
display information for informing to change a state of the other electronic device, using the display,
transmit, to the other electronic device, a signal indicating to identify whether the state is changed via the connection using the wireless communication circuitry, and
in response to displaying of the information or transmitting of the signal indicating to identify whether the state is changed, identify whether a signal indicating that the state is changed is received from the other electronic device within another defined time, and
based at least in part on identifying that the signal indicating that the state is changed is received from the other electronic device within the other defined time, register the other electronic device to the external electronic device.

7. The electronic device of claim 1, further comprising:
a display,
wherein the instructions, when executed by the at least one processor individually or collectively, further cause the electronic device to:
based on registering of the other electronic device, display information for informing that the another electronic device is registered, using the display.

8. An electronic device comprising:
a display;
wireless communication circuitry;
at least one processor comprising processing circuitry; and
memory comprising one or more storage media storing instructions,
wherein the instructions, when executed by the at least one processor individually or collectively, cause the electronic device to:
receive a first advertising signal broadcasted from another electronic device with a first transmit (Tx) power from among the first advertising signal and a second advertising signal broadcasted from the other electronic device with a second Tx power lower than the first Tx power, using the wireless communication circuitry,
based on a reception strength of the first advertising signal greater than a reference reception strength, transmit, to the other electronic device, a connection request, using the wireless communication circuitry,
in response to a connection with the other electronic device established based at least in part on the connection request, display information for informing to access the other electronic device, and identify whether the second advertising signal is received within a defined time, and
based at least in part on the second advertising signal received within the defined time, register the other electronic device to an external electronic device.

9. The electronic device of claim 8, wherein the instructions, when executed by the at least one processor individually or collectively, further cause the electronic device to:
receive, from the other electronic device through the connection, information regarding an identity resolving key (IRK), using the wireless communication circuitry; and
register the other electronic device to the external electronic device, based at least in part on identifying that a random address in the second advertising signal received within the defined time is resolved based on the IRK.

10. The electronic device of claim 8, further comprising:
another wireless communication circuitry,
wherein the instructions, when executed by the at least one processor individually or collectively, further cause the electronic device to:
in response to the second advertising signal received within the defined time, transmit a signal requesting security information of the other electronic device, through the connection, using the wireless communication circuitry,
receive, from the other electronic device through the connection, the security information, using the wireless communication circuitry, and
register the other electronic device to the external electronic device, based on transmitting the security information to the external electronic device using the other wireless communication circuitry.

11. The electronic device of claim 10, wherein the instructions, when executed by the at least one processor individually or collectively, further cause the electronic device to:
receive, from the external electronic device, a signal indicating that the other electronic device is authenticated based on the security information, using the other wireless communication circuitry, and
register the other electronic device to the external electronic device, based on the signal indicating that the other electronic device is authenticated.

12. The electronic device of claim 8, wherein the instructions, when executed by the at least one processor individually or collectively, further cause the electronic device to:
based on identifying that the second advertising signal is not received within the defined time, display information for informing to change a state of the other electronic device using the display, and transmit, to the other electronic device, a signal indicating to identify whether the state is changed, through the connection using the wireless communication circuitry,
in response to displaying of the information for informing to change the state or transmitting of the signal indicating to identify whether the state is changed, identify whether a signal indicating that the state is changed is received from the other electronic device within another defined time, and
register the another electronic device to the external electronic device, based at least in part on identifying that the signal indicating that the state is changed is received from the another electronic device within the another defined time.

13. The electronic device of claim 8, wherein the instructions, when executed by the at least one processor individually or collectively, further cause the electronic device to, based on registering of the other electronic device, display information for informing that the other electronic device is registered, using the display.

14. The electronic device of claim 8, wherein the instructions, when executed by the at least one processor individually or collectively, further cause the electronic device to establish the connection based at least in part on receiving a connection response transmitted from the other electronic device in response to the connection request.

15. An electronic device comprising:
a display;
wireless communication circuitry;
at least one processor comprising processing circuitry; and
memory comprising one or more storage media storing instructions,
wherein the instructions, when executed by the at least one processor individually or collectively, cause the electronic device to:
receive a first advertising signal broadcasted from another electronic device with a first transmit (Tx) power from among the first advertising signal and a second advertising signal broadcasted from the other electronic device with a second Tx power lower than the first Tx power, using the wireless communication circuitry,
based on a reception strength of the first advertising signal greater than a reference reception strength, display information for informing to access the other electronic device, using the display, and identify whether the second advertising signal is received within a defined time,
establish a connection with the other electronic device, based on the second advertising signal received within the defined time, and
register the other electronic device to an external electronic device, based at least in part on establishing of the connection.

16. The electronic device of claim 15, further comprising:
another wireless communication circuitry,
wherein the instructions, when executed by the at least one processor individually or collectively, further cause the electronic device to:
transmit a signal requesting security information of the other electronic device, through the connection, using the wireless communication circuitry,
receive, from the other electronic device through the connection, the security information, using the wireless communication circuitry, and
register the other electronic device to the external electronic device, based on transmitting the security information to the external electronic device using the other wireless communication circuitry.

17. The electronic device of claim 16, wherein the instructions, when executed by the at least one processor individually or collectively, further cause the electronic device to:
receive, from the external electronic device, a signal indicating that the other electronic device is authenticated based on the security information, using the other wireless communication circuitry, and
register the other electronic device to the external electronic device, based on the signal indicating that the other electronic device is authenticated.

18. The electronic device of claim 15, wherein the instructions, when executed by the at least one processor individually or collectively, further cause the electronic device to:
based on identifying that the second advertising signal is not received within the defined time, transmit, to the other electronic device, a connection request, using the wireless communication circuitry,
based on the connection established based at least in part on the connection request, display information for informing to change a state of the other electronic device, using the display, and transmit, to the other electronic device, a signal indicating to identify whether the state is changed through the connection by using the wireless communication circuitry,
in response to displaying of the information for informing to change the state or transmitting of the signal indicating to identify whether the state is changed, identify whether a signal indicating that the state is changed is received from the other electronic device within another defined time, and
register the other electronic device to the external electronic device, based at least in part on identifying that the signal indicating that the state is changed is received from the other electronic device within the other defined time.

19. The electronic device of claim 15, wherein the instructions, when executed by the at least one processor individually or collectively, further cause the electronic device to display information for informing that the other electronic device is registered using the display, based on registering of the other electronic device.

20. The electronic device of claim 15, wherein the instructions, when executed by the at least one processor individually or collectively, further cause the electronic device to:
in response to the second advertising signal received within the defined time, transmit, to the external electronic device, a connection request, using the wireless communication circuitry, and
establish the connection based at least in part on receiving a connection response transmitted from the another electronic device in response to the connection request.
